(19) United States
(12) Patent Application Publication
(10) Pub. No.: US 2011/0215001 A1
(43) Pub. Date: Sep. 8, 2011

(54) Electrochemical Removal of Arsenic

(75) Inventors: Ashok Jagannath Gadgil, El Cerrito, CA (US); Susan E. Addy, Berkeley, CA (US); Robert Kostecki, Lafayette, CA (US)

(73) Assignee: The Regents of The University of California

(21) Appl. No.: 13/060,674

(22) PCT Filed: Aug. 27, 2009
(86) PCT No.: PCT/US09/55220

§ 371 Date: May 13, 2011

Related U.S. Application Data
(60) Provisional application No. 61/093,245, filed on Aug. 29, 2008.

(51) Int. Cl. C02F 1/461; C02F 1/62; C02F 1/463; C02F 101/20

(52) U.S. Cl. 205/750; 204/242; 205/761; 205/751

(57) ABSTRACT

The present invention provides for a system for removing arsenic from an arsenic contaminated aqueous solution, and its use thereof. The system comprises an anode comprising iron and a cathode comprising iron or an electricity conducting metal that is electropositive relative to iron in contact with the arsenic contaminated aqueous solution. The system is used by running an electric current through the water via the anode and cathode to cause the formation of iron (hydr)oxide from the iron of the anode which then forms an insoluble arsenic-iron (hydr)oxide complex which can be separated from the aqueous solution.

### CROSS-REFERENCE TO RELATED APPLICATIONS

This application claims priority to U.S. Provisional Patent Application Ser. No. 61/093,245, filed on Aug. 29, 2008, which is hereby incorporated by reference.

### STATEMENT OF GOVERNMENTAL SUPPORT

The invention described and claimed herein was made in part utilizing funds supplied by the U.S. Department of Energy under Contract No. DE-AC02-05CH11231. The government has certain rights in this invention.

### FIELD OF THE INVENTION

This invention relates generally to arsenic removal from water.

### BACKGROUND OF THE INVENTION

Arsenic in drinking water is a major public health problem threatening the lives of over 140 million people worldwide. Primary drinking water supplies are contaminated in Argentina, Chile, Mexico, China, Hungary, Cambodia, Vietnam, West Bengal (India), Bangladesh, and areas of the United States. In Bangladesh alone, between 35-77 million people drink arsenic-laden water from shallow wells, leading to what has aptly been called the largest mass poisoning of a population in history. Over one million deaths are expected due to arsenic-related cancer in Bangladesh. Millions more will suffer from arsenic-related medical conditions unless something is done.

The primarily rural population of Bangladesh is too poor to afford arsenic remediation techniques that are cost effective only on large scales. Current technical approaches to low-cost arsenic removal involve the addition of chemical adsorbents, which frequently exhibit one or more of the following environmentally degrading qualities: toxicity, use of strong alkalies or corrosive acids to regenerate, production of large quantities of arsenic-laden toxic waste, a short shelf life, and/or the need for an extensive supply chain with corresponding greenhouse gas emissions. In addition, these technologies are often deployed as point-of-use devices, to be operated and maintained by the user. Point-of-use systems have been plagued by high abandonment rates after a short time due to difficult maintenance or operation, lack of time to devote, and low cultural acceptability. Current arsenic remediation technologies have been employed as chemical adsorbents in point-of-use systems—placing the burden of maintenance and operation on the end-user. These systems have been plagued by high abandonment rates after a short time, due to difficult maintenance or operation, lack of time to devote, and low cultural acceptability. In addition chemical adsorbents have limited effectiveness in removing As(III), which makes up about 70-90% of the total arsenic measured in Bangladeshi tubewells. A new model is needed to ensure sustainability of water treatment for future generations.

U.S. Pat. Nos. 5,858,249 and 6,264,845, and International Patent Application No. PCT/US98/18406, disclose a method and apparatus for electrochemically removing arsenic from an aqueous solution by forming solid ferric arsenate (FeAsO₄).

### SUMMARY OF THE INVENTION

The present invention provides for a system for removing arsenic from an aqueous solution, comprising: (a) an aqueous solution comprising arsenic, (b) an anode, and (c) a cathode, wherein the anode and cathode are in contact with the aqueous solution comprising arsenic and in electrical communication; wherein the anode comprises iron and the cathode comprises iron or an electricity conducting metal that is electropositive relative to iron.

The present invention provides for a method for removing arsenic from an aqueous solution comprising arsenic comprising: (a) providing the system for removing arsenic from an aqueous solution of the present invention; (b) running a direct or alternating current through the water via the anode and cathode which causes the formation of iron (hydr)oxide from the iron of the anode; (c) forming an arsenic-iron (hydr)oxide complex; and (d) separating the arsenic-iron (hydr)oxide complex from the aqueous solution.

The method of the present invention can further comprise the step of replacing the anode with a second anode comprising of iron or adding more iron to the anode. The method of the present invention can further comprise the step of adding a second aqueous solution comprising arsenic. The method of the present invention can further comprise: (e) replacing the anode with a second anode comprising of iron or adding more iron to the anode, (f) adding a second aqueous solution comprising arsenic, and repeating steps (b) to (d).

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows a schematic of Fe(III) ions entering solution from the electrochemical dissolution of an iron anode, hydrolyzing into rust (represented by Fe(OH)₃) and binding to As(V) oxyanions for removal from drinking water. See the definition of “complexation with iron (hydr)oxide” provided herein.

FIG. 2 shows the percentage of total arsenic removal as a function of processing time after 60 minutes of stirring.

FIG. 3 shows the total arsenic concentration as a function of processing time after 60 minutes of stirring.

FIG. 4 shows two electrochemical cells. Panel A shows a schematic representation of an 850 mL, separated cathode electrochemical cell. Panel B shows a schematic representation of 3 liter, single chamber electrochemical cell.

FIG. 5 shows the total aqueous arsenic concentration (left side axis) and % arsenic removal (right side axis) for ECAR treatment of synthetic Bangladesh groundwater as a function of current processing time (also called residence time) for current densities 0.07-1.1 mA/cm² as well as tests with no external voltage applied to the cell. In the case of no external voltage, processing time refers to the amount of time electrodes were left sitting in the solution. Lines are added between points to help guide the eye. All solutions are stirred for 60 minutes after the processing time.

FIG. 6 shows the total aqueous arsenic concentration (left side axis) and % arsenic removal (right side axis) for ECAR treatment of synthetic Bangladesh groundwater (recipe-1) as a function of charge density for current densities 0.07-1.1 mA/cm².

FIG. 7 shows the total aqueous arsenic concentration (left side axis) and % arsenic removal (right side axis) in synthetic Bangladesh groundwater (recipe-2) as a function of charge density for current densities 0.02-30 mA/cm².

FIG. 8 shows the As(III) and As(V) aqueous arsenic concentration (left side axis) and % arsenic removal (right side axis) as a function of charge density. Percent arsenic removal is based on the average initial concentration of As(III) and As(V).

FIG. 9 shows the final aqueous As(III) concentration in solution (initial concentration 300 ppb) for synthetic Bangladesh groundwater after ECAR treatment at 5 mA/cm² (left bar), and post-synthesis sorption batch experiments with ECAR-generated iron (hydr)oxides aged for 0 minutes (middle bar) and 60 minutes (right bar) prior to addition of arsenic.

FIG. 10 shows total aqueous arsenic concentration as a function of mixing time after ECAR treatment of synthetic Bangladesh groundwater at 1.1. mA/cm² and 100 C/L applied. These results demonstrate a drop in arsenic concentration as a function of mixing time, and are not meant to demonstrate the maximum possible drop in arsenic concentration as a function of mixing time or the minimum arsenic concentration achievable through increasing the mixing time.

FIG. 11 shows the pre- and post-treatment arsenic concentrations for four tubewell samples (TW) along with one synthetic Bangladesh groundwater sample (SBGW). Removal to below the WHO limit (10 ppb) was observed in each case. The left bars indicate the pre-treatment arsenic levels (ppb) and the right bars indicate post-treatment arsenic levels (ppb).

FIG. 12 shows the aqueous arsenic concentration as a function of charge density for three different initial arsenic concentrations. The lower plot is identical to the upper plot, except for the Y-axis scale (reduced to highlight detail). A dashed line indicates the WHO recommended maximum arsenic limit at 10 ppb, and a dotted line indicates the Bangladesh legal maximum arsenic limit at 50 ppb.

FIG. 13 shows the arsenic concentration as a function of charge density (in Coulombs per liter) for batch tests in the 20 L prototype using different methods of agitation. The first method used is a series of impellers, operating at fast, medium, and slow rotation speeds. The second method of agitation used is aeration. A mixing time of 0 min (i.e. no mixing) was used for each of the above tests. The WHO maximum recommended limit for arsenic in drinking water (10 ppb) is shown as a dashed line

FIG. 14 shows the arsenic concentration in the 20 L prototype after 70 min of dosing (tₘ=0; grey bars) and after 70 min of dosing plus an addition 30 minutes of post-electrolysis mixing (tₘ=30 min; white bars). Agitation methods and speeds used include aeration (left), slow speed impellers (middle), and medium speed impellers (right).

FIG. 15 shows the arsenic concentration as a function of charge density (in Coulombs per liter) for batch tests in the 20 L prototype using a different number of plates in different plate configurations. In one configuration, 6 plates are placed in the center of the 20 L prototype volume, spaced 2 cm apart. In a second configuration, 6 plates are placed uniformly throughout the full 20 L prototype volume, spaced 8 cm apart. In the third configuration, 22 plates are placed uniformly throughout the full 20 L prototype volume, spaced 2 cm apart. The WHO maximum recommended limit for arsenic in drinking water (10 ppb) is shown as a dashed line.

FIG. 16 shows supernatant arsenic concentration after 30 minutes of settling for a control sample (no coagulant added) and an alum sample (100 mg/L alum added) of ECAR-generated particles.

FIG. 17 shows supernatant arsenic concentration in settling beakers containing polyelectrolyte or polyacrylamide coagulant at various concentrations, plus a control (no added coagulant). Absent bars indicate absent data as opposed to a value of 0.

FIG. 18 shows supernatant arsenic concentration after 1 minute and 13 hr 30 min of settling for beakers with different concentrations of ECAR-generated adsorbent, or sludge. The control in this series is 150 C/L, which represents the charge density needed to reduce arsenic to the WHO limit (10 ppb) in synthetic Bangladesh groundwater. Note that the arsenic concentration for 130,107 C/L at 13 hr 30 min is not detected (0) rather than absent data.

FIG. 19 shows supernatant arsenic concentration after 9 hr 15 min and 21 hr 15 min settling for settling beakers with a different pH, concentration of NaCl, or concentration of polyelectrolyte compared to a control at pH 7. Absent bars indicate absent data as opposed to a value of 0.

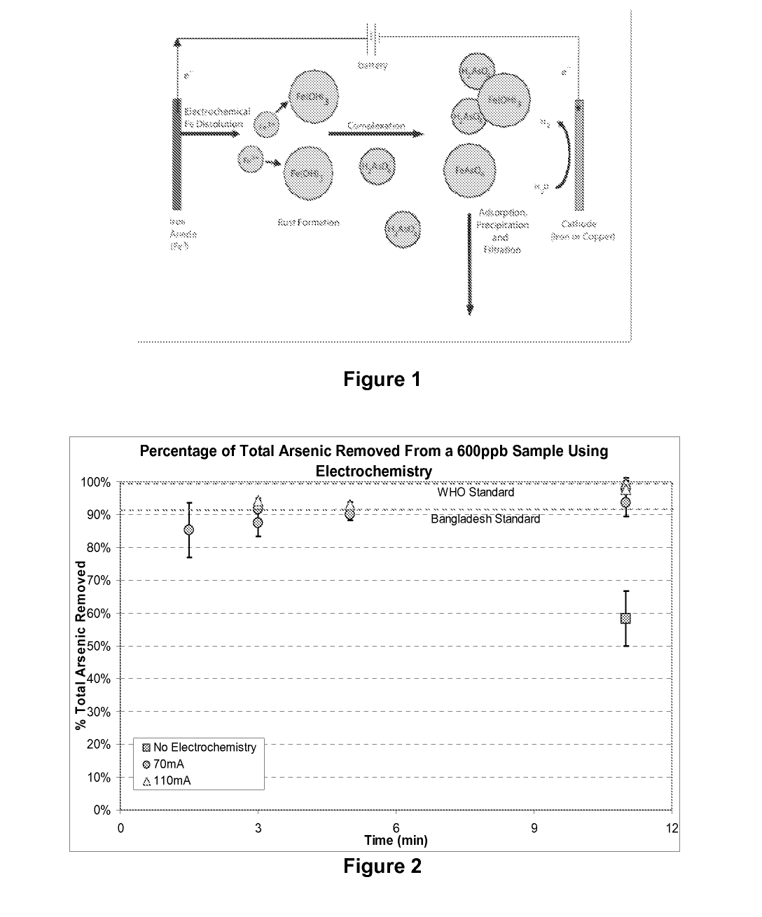

### DETAILED DESCRIPTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “an oxide” includes a plurality of such oxides, and so forth.

### DEFINITIONS

In this specification and in the claims that follow, reference will be made to a number of terms that shall be defined to have the following meanings:

The term “iron (hydr)oxide” defines one or more species of iron hydroxide, iron oxyhydroxide, iron oxide, or any mixture thereof, wherein the iron is an Fe²⁺ or Fe³⁺ cation or (Fe(II) or Fe(III)), or a mixture thereof. Examples of iron (hydr)oxides include, but are not limited to, the members listed in Table 1.

TABLE 1
Iron (hydr)oxides (taken from Cornell, R.
M. and Schwertmann, U., The Iron Oxides, Wiley-
VCH GmbH & Co. KGaA, Weinheim, 2003).

| Oxyhydroxides and Hydroxides | Oxides |
|---|---|
| Goethite α - FeOOH | Hematite α - Fe₂O₃ |
| Lepidocrocite γ - FeOOH | Magnetite |
| Akaganeite β - FeOOH | Fe₃O₄(Fe^{II}Fe₂^{III}O₄) |
| Schwertmannite Fe₁₆O₁₆(OH)_{y}(SO₄)_{z}•nH₂O | Maghemite γ - Fe₂O₃ |
| δ - FeOOH | β - Fe₂O₃ |
| Feroxyhyte γ′ - FeOOH | ε - Fe₂O₃ |
| High Pressure FeOOH | Wustite (FIX U) FeO |
| Ferrihydrite Fe₅HO₈•4H₂O | |
| Bernalite Fe(OH)₃ | |
| Fe(OH)₂ | |
| Green Rusts Feₓ^{III}F_{y}^{II}(OH)_{3x+2y-z}(A⁻)_{z}; | |
| A⁻ = Cl⁻; (½)SO₄²⁻ | |

The term “complexation with iron (hydr)oxide” is defined as the adsorption or chemisorption, or a mixture thereof, of arsenic with one or more species of iron (hydr)oxide, or mixture thereof. Adsorption is the accumulation of a substance at or near an interface relative to its concentration in the bulk solution, also called surface complexation. The substance that adsorbs is called the adsorbate, and the solid to which it binds is called the adsorbent. Chemisorption is the adsorption by chemical interactions between the adsorbate and surface rather than electrostatic interactions, whereby the adsorbate is specifically or chemically adsorbed. In one example, Fe(II) ions could dissolve from the anode and hydrolyze, forming Fe(II) (hydr)oxides or oxidize to form Fe(III) (hydr)oxides.

The term “ElectroChemical Arsenic Remediation” or “ECAR” is defined as process of arsenic removal utilizing electrocoagulation (EC) processes.

These and other objects, advantages, and features of the invention will become apparent to those persons skilled in the art upon reading the details of the invention as more fully described below.

The present invention provides for a system for removing arsenic from an aqueous solution, comprising: an aqueous solution comprising arsenic, an anode and a cathode, wherein the anode and cathode are in contact with the aqueous solution comprising arsenic and in electrical communication; wherein the anode comprises iron and the cathode comprises iron or an electricity conducting metal that is electropositive relative to iron.

The device does not require the arsenic contaminated water or aqueous solution to be in motion or flowing in order for removal of the arsenic to take place. The arsenic contaminated water or aqueous solution can be stationary. In some embodiments, the aqueous solution can be stationary, i.e., it is not in motion or flowing. In other embodiments, the aqueous solution is in motion or flowing but there is no addition of further bodies of aqueous solution comprising arsenic. The aqueous solution comprising arsenic is a body of arsenic contaminated water. In some embodiments, the aqueous solution comprises 10 or more parts per billion (ppb) of arsenic. In some embodiments, the aqueous solution comprises 100 or more parts per billion (ppb) of arsenic. In some embodiments, the aqueous solution comprises 200 or more parts per billion (ppb) of arsenic. In some embodiments, the aqueous solution comprises 500 or more parts per billion (ppb) of arsenic. In some embodiments, the aqueous solution comprises 600 or more parts per billion (ppb) of arsenic. In some embodiments of the invention, the aqueous solution has a pH from at least 5 to no more than 9.

In some embodiments of the invention, the aqueous solution comprising arsenic of the system is contained in a vessel comprising a non-electricity conducting and inert material. Examples of such non-electricity conducting and inert materials include, but are not limited to, wood, glass, and plastic. In other embodiments of the invention, the aqueous solution comprising arsenic of the system is contained in a vessel comprising the anode or cathode.

During operation of the system, the system further comprises an electric cell in electrical communication between the anode and the cathode. The electric cell produces an electrical potential sufficient to produce Fe²⁺ or Fe³⁺ cations, or a mixture thereof, from the anode. In some embodiments, the anode is pure iron. During the operation of the system, the iron of the anode is progressively oxidized, i.e., corroded and/or consumed.

In some embodiments the anode comprises iron (nails, filings or any other suitable metallic form) that is kept in contact through water (which acts as the electrolyte). The area of the electropositive metal in contact with the electrolyte of the cathode should be large enough to avoid kinetic limitations on the reduction processes occurring at the cathode. The volume of the electropositive metal is not relevant, only the large area is relevant. Thus, in one embodiment, the cathode comprises a food-grade plastic that has been coated with a vacuum sputtered layer of a suitable metal (such as, silver or copper) of a modest thickness, such as about 100 μm. The electropositive metal layer is not damaged or corroded in this process. It is only the iron of the anode that rusts rapidly. Once the iron has rusted away, it can be replaced with more iron, leaving the electropositive metal layer to continue to provide the electromotive force to accelerate the corrosion.

In some embodiments, the anode is portable or can be hand-held by a human operator, wherein the anode is small enough to fit in a bowl or cup or container that is equal to less than 5 L, 2 L, 1 L or 500 mL. The anode can further comprise a handle designed for the anode to be held by a human hand, wherein the handle comprises an insulator or material that does not conduct electricity.

In some embodiments, the anode comprises iron nails or iron filings or any relevant metal form between two perforated sheets of the selected electropositive metal (i.e., electropositive with respect to iron), such as copper, silver, or carbon. It is calculated that such a perforated sheet offers much larger area than adding a small amount of electropositive metal coating to the iron metal form.

In some embodiments, the electricity conducting metal that is electropositive relative to iron is cobalt, nickel, lead, copper, mercury, silver, platinum, or gold, or a mixture thereof. The cathode is not structured to form a reaction zone therebetween through an aqueous solution can pass. In some embodiments, the cathode is designed to have as large a surface area as possible in contact with the aqueous solution. The cathode can comprise the electricity conducting metal that is electropositive relative to iron covering a non-conducting material, such as plastic. In some embodiments, the thickness of the electricity conducting metal can be as thin as 100 μm. In some embodiments of the invention, during the operation of the system, no part or portion of the cathode is corroded or consumed. The electricity conducting metal is not corroded, damaged, or consumed during the operation of the system.

In some embodiments of the invention, the cathode comprises a copper or silver surface can be used, such as a copper or silver surface on a plastic sheet. A large piece of the electricity conducting metal that is electropositive relative to iron, such as a large piece of solid copper or silver, is not necessary.

In some embodiments, there is an ion permeable membrane that separates the cathode compartment from the Fe anode compartment. That the cathode does not interact with the volume of arsenic in the anode compartment makes the device very efficient. During the operation of the system an external potential is applied across the cathode and the anode. The application of the external potential causes the formation of the iron (hydr)oxides.

During the operation of the system in removing arsenic from the aqueous solution, the aqueous solution further comprises an arsenic-iron (hydr)oxide complex. The arsenic-iron (hydr)oxide is insoluble or poorly soluble in the aqueous solution and is solid. The arsenic-iron (hydr)oxide has a density higher than the density of the aqueous solution.

The method of the present invention may involve ECAR. ECAR comprises of at least three steps: dosing, incubating, and separating. The dosing step takes place in which electrodes are in contact with solution and an external voltage may or may not be applied. During this step, one or more of the following may occur: iron (hydr)oxides are electrochemically generated in solution, electrocoagulation and aggregation of iron (hydr)oxides, electrocoagulation and aggregation of arsenic oxyanions, complexation between arsenic and iron (hydr)oxides, settling or flotation of arsenic-iron (hydr)oxide complexes. The incubating step is the step in which the electrodes are removed from solution, or remain in contact with the solution but are electrically disconnected, or remain in contact with the solution but external voltage is turned off, and during which time the solution is mixed, stirred, agitated, or left quiescent, or subjected to a combination thereof. During this step, one or more of the following may occur: coagulation and aggregation of iron (hydr)oxides, coagulation and aggregation of arsenic oxyanions, complexation between arsenic and iron (hydr)oxides, settling of arsenic-iron (hydr)oxide complexes. The separation step is the step in which aggregated arsenic-iron (hydr)oxide complexes are separated from solution through filtration or decantation after complexes have had time to settle, or some other method of separating the complexes from solution. Processing Time or Residence Time refers to the duration of the dosing step (i.e. electrodes in contact with solution and external voltage applied. If no external voltage is applied, then it is the time the electrodes are in contact with solution and electrically connected. Incubation Time refers to the duration of the incubating step, which may further comprise by an additional duration of quiescent settling before separation occurs. Charge Density, q, also called Charge Loading, or Charge per Liter, is calculated from the operating current via q=I*tp/V where I is the operating current, tp is the processing time (or residence time) and V is the solution volume in contact with the electrodes.

The formation of the arsenic-iron (hydr)oxide complex involves the process of electrocoagulation (EC). The present invention utilizes EC as a means to remove arsenic from a solution. In EC, electricity is used to continuously dissolve iron ions, which quickly hydrolyze and form corrosion products such as ferric hydroxides, ferric oxyhydroxides, and ferric oxides (collectively called ferric (hydr)oxides or rust), with a high affinity for arsenic. During EC, coagulation may also be enhanced as charged particles move in the applied electric field and neutralize ionic species in solution. Neutralization or partial neutralization reduces electrostatic repulsion, aiding coagulation and aggregation into flocs. The flocs can create a sludge blanket able to entrap and bridge colloidial particles. EC overcomes many of the obstacles of chemical adsorbents and can be used affordably and on a small-scale, allowing for rapid dissemination into countries, such as Bangladesh, to address any arsenic crisis. In EC, electricity is used to continuously dissolve an iron anode and dose the solution with iron (hydr)oxides. Thus the arsenic adsorbent is manufactured at the time of use—eliminating the need for a costly supply chain. In addition, this process greatly enhances the capacity of the iron (hydr)oxide or rust to adsorb arsenic, due to (1) an increase in the rate of iron (hydr)oxide or rust production, depending on the applied current (usually, by several orders of magnitude higher than typical iron rusting rate under ambient conditions), and (2) the rapid oxidation of As(III) in the water to the more favorable As(V) which binds much more readily to the iron (hydr)oxide or rust. Thus the employment of a small amount of electricity leads to a large advantage in efficiency and processing time, lowering the cost and producing far less waste than chemical adsorbents. In addition, the electrodes are self-cleaning if current is alternated, reducing maintenance and eliminating the need for corrosive acids or toxic chemicals for regeneration.

The present invention makes use of the process whereby arsenic is adsorbed onto the surface of iron (hydr)oxide, such as iron hydroxides, iron oxides, and/or iron oxyhydroxides. The device does not or does not need to primarily produce ferric arsenate (FeAsO₄). The arsenic in the aqueous solution is primarily removed as it is adsorbed onto the iron (hydr)oxide, such as iron hydroxides, iron oxides, and/or iron oxyhydroxides, and does not form ferric arsenate.

The present invention provides for a method for removing arsenic from an aqueous solution comprising arsenic comprising: (a) providing the system for removing arsenic from an aqueous solution of the present invention; (b) running a direct or alternating current through the water via the anode and cathode which causes the formation of iron (hydr)oxide from the iron of the anode; (c) forming an arsenic-iron (hydr)oxide complex; and (d) separating the arsenic-iron (hydr)oxide complex from the aqueous solution.

The practice of the invention results in the removing of arsenic from the aqueous solution. In some embodiments of the invention, the practice of the invention results in an aqueous solution having less than 10 ppb of arsenic in the aqueous solution. In some embodiments of the invention, the practice of the invention results in an aqueous solution having less than 8 ppb of arsenic in the aqueous solution. In some embodiments of the invention, the practice of the invention results in an aqueous solution having less than 5 ppb of arsenic in the aqueous solution. In some embodiments of the invention, the practice of the invention results in a aqueous solution having less than 3.5 ppb of arsenic in the aqueous solution.

To reach a level of 10 or less ppb of arsenic in the aqueous solution with initial arsenic concentration of 600 ppb comprising equal amounts of AsIII and AsV, and in the presence of competing ions typical of ground waters in Bangladesh as described by the British Geological Survey (BGS, 2001. Arsenic contamination of groundwater in Bangladesh. WC/00/19, British Geological Survey, Keyworth.), the charge density applied should be at least 150 C/L. Such completing ions include, but are not limited to bicarbonate, phosphate, sulfate, manganese, iron, and sulfate.

In some embodiments of the invention, the separating step comprises filtering the aqueous solution comprising the arsenic-iron (hydr)oxide complex with a filter such that the aqueous solution is the filtrate that passes through the filter and the arsenic-iron (hydr)oxide complex is the residue that is captured by the filter. The filter can be any physical filter that has a pore size smaller than the size of the coagulated particulates of arsenic-iron (hydr)oxide complex.

In some embodiments of the invention, the separating step comprises a quiescent period in which all solids, including the arsenic-iron (hydr)oxide complex, are allowed to settle. Water with a reduced arsenic concentration is decanted from above the settled particles.

In some embodiments of the invention, the separating step is completed via electroflotation. In electroflotation, bubbles formed from electrochemical reactions at the anode and/or cathode attach to arsenic-iron (hydr)oxide complexes and/or other contaminants in solution and float them to the surface. The surface sludge can be skimmed away or water can be decanted from the bottom or side of the vessel to avoid surface sludge.

The method of the present invention can further comprise the step of replacing the anode with a second anode comprising of iron or adding more iron to the anode. The method of the present invention can further comprise the step of adding a second aqueous solution comprising arsenic. The method of the present invention can further comprise: (e) replacing the anode with a second anode comprising of iron or adding more iron to the anode, (f) adding a second aqueous solution comprising arsenic, and repeating steps (b) to (d).

In some embodiments, the separating step comprises removing the aqueous solution and arsenic-iron (hydr)oxide complex from the system and physically removing the arsenic-iron (hydr)oxide complex from the aqueous solution, and the method further comprises adding a second aqueous solution comprising arsenic to the system.

In some embodiments of the invention, during steps (b) and (c), the aqueous solution is stationary, not in motion, or non-flowing. In other embodiments, during steps (b) and (c) the aqueous solution is in motion or flowing but there is no addition of further bodies of aqueous solution comprising arsenic.

The present invention can be used for removing arsenic from water by reacting the water and arsenic with iron (hydr)oxide formed on-site using electrochemical methods. In some embodiments of the present invention, the invention can be used in small households or a few households, for drinking water only.

In some embodiments of the invention, an electric current is applied to two iron (or one iron and one copper) wires in contaminated water. The electric current pulls electrons from the iron anode, causing metallic iron, Fe⁰, to oxidize and form Fe²⁺ and/or Fe³⁺ ions and various forms of iron (hydr)oxide or rust. The rust that consists of iron hydroxides, iron oxyhydroxides, and/or iron oxides, or a mixture thereof, captures arsenic present in the water, forming an insoluble complex. The arsenic-iron (hydr)oxide complex coagulates into larger particles and then is separated from the water by filtration using sand filter or decantation. The remaining water is arsenic-free and iron-free.

In other embodiments of the present invention, the invention can be used for drinking water systems in Bangladesh, India, Nepal, and/or other countries, since the iron (hydr)oxide production can be built into channels of iron sheets supplied with DC voltage immersed in flowing water. The unreacted iron (hydr)oxide as well as the one that reacts with arsenic, both can be removed using sedimentation and filtration, since both are insoluble in water.

In some embodiments, the method for removing arsenic from an aqueous solution comprising arsenic comprises: (a) providing the system for removing arsenic from an aqueous solution of the present invention; (b) running a direct or alternating current through the water via the anode and cathode which causes the formation of iron (hydr)oxide from the iron of the anode; (c) forming an arsenic-iron (hydr)oxide complex; (d) separating the arsenic-iron (hydr)oxide complex from the aqueous solution; and (e) replacing the anode with a second anode comprising of iron or adding more iron to the anode.

In some embodiments, the method for removing arsenic from an aqueous solution comprising arsenic comprises: (a) providing the system for removing arsenic from an aqueous solution of the present invention; (b) running a direct or alternating current through the water via the anode and cathode which causes the formation of iron (hydr)oxide from the iron of the anode; (c) forming an arsenic-iron (hydr)oxide complex; (d) separating the arsenic-iron (hydr)oxide complex from the aqueous solution; (e) replacing the anode with a second anode comprising of iron or adding more iron to the anode; (f) adding a second aqueous solution comprising arsenic, and optionally repeating steps (b) to (d).

In some embodiments, the system can further comprise a suitable coagulant. In some embodiments of the method of the present invention can further comprise: introducing a suitable coagulant to the aqueous solution. In some embodiments, the coagulant is introduced to the aqueous solution when the aqueous solution is stationary, not in motion, or non-flowing. Suitable coagulants include, but are not limited to, alum, a polyelectrolyte, and a polyacrylamide, or a copolymer thereof. When alum is introduced as a coagulant, the alum can be introduced to a concentration from more than 0 mg/L to about 200 mg/L. In some embodiments, the alum is introduced to a concentration from about 50 mg/L to about 150 mg/L. In some embodiments, the alum is introduced to a concentration from about 90 mg/L to about 110 mg/L. Polyelectrolytes are polymers whose repeating units bear an electrolyte group. When a polyelectrolyte is introduced as a coagulant, the polyelectrolyte can be introduced to a concentration from more than 0 mg/L to about 100 mg/L. A copolymer of a polyacrylamide comprises one or more other chemical species, such as an acrylic acid or a salt thereof. When a polyacrylamide, or copolymer thereof, is introduced as a coagulant, the polyacrylamide, or copolymer thereof, can be introduced to a concentration from more than 0 mg/L to about 50 mg/L.

In some embodiments of the invention, the system or method of the invention can comprise the use of a charge density up to about 150,000 C/L, or up to about 50,000 C/L, or up to about 1,000 C/L, or up to about 50° C./L, or up to about 20° C./L.

In some embodiments of the invention, the system or method of the invention can comprise increasing the pH value of the aqueous solution up to about 8 pH, or up to about 8.5 pH, or up to about 9 pH, or up to about 10 pH.

The advantages of at least some embodiments of the invention include, but are not limited to, the capability of operating without turbulence of the water or solution, the cathode can be separate from the arsenic, the device can be operated without an applied voltage, and the precipitate can be removed.

The invention having been described, the following examples are offered to illustrate the subject invention by way of illustration, not by way of limitation.

### Example 1

### Electrochemical Cell for Removing Arsenic from Water

Experiments were executed using water batches that were prepared following UNESCO specifications and protocol (Petrusevski B., Boere J., Shahidullah S. M., Sharma S. K., Schippers J. C. “Adsorbent-based point-of-use system for arsenic removal in rural areas” Aqua—J. Water Supply: Res. and Tech. 51(3):135-144, 2002, hereby incorporated by reference) excluding the iron and manganese concentrations mentioned in the publication. The reason to exclude the iron and manganese ions is that the operation of the cell introduces far higher concentrations of iron. These water batches model Bangladesh groundwater in order to ensure that removal processes performed in the lab will perform similarly when put into place in Bangladesh. All chemicals used were analytical reagent grade. All aqueous solutions were prepared in distilled water. Table 2 shows the composition of the model water. Each 8 L water batch consisted of 300 ppb of As(III) and 300 ppb of As(V). Each batch was bubbled with N₂ gas in order to deoxygenate the water to a dissolved oxygen (DO) level below 3.0 mg/L and bubbled with CO₂ gas in order to lower the pH below 6.8. Bangladesh groundwater tends to have a pH between 6.8-7.2 and DO levels below 2.5 mg/L.

TABLE 2
Composition of model water

| Parameter | Ca | Mg | SO₄ | Cl | Na | PO₄ |
|---|---|---|---|---|---|---|
| mg/L | 53 | 7.9 | 81 | 125 | 134 | 0.03 |

Each batch experiment consisted of 850 mL of UNESCO water that was stirred during the entire length of the experiment. An iron coil electrode and copper mesh electrode were used for each batch experiment. The iron electrode was rinsed with a 19% HCl aqueous solution followed by deionized water after every third experiment in order to remove any rusting from the electrode. Excessive rusting on the electrode has been found to decrease the efficiency. A Schott filter equipped with a porous glass frit membrane was placed in the beaker and was used as a cathode compartment to separate the copper and iron electrodes in order to prevent the excessive reduction of As(V) to As(III) on the Cu cathode. A Princeton Applied Research® Potentiostat (Model 173) was used to apply current to both electrodes. The current was adjusted to either 70 mA or 110 mA and was applied for varying amounts of time. Once the desired time was reached, a 150 ml sample was taken and the remaining water batch was stirred for an additional 60 minutes with samples taken after 20, 40 and 60 minutes. Longer stirring times allow increased precipitation and/or increased coagulation of either iron (hydr)oxides or arsenic-iron (hydr)oxide complexes and/or further adsorption or complexation arsenic to insoluble iron (hydr)oxides.

A vacuum Büchner filtering apparatus with a 90 mm, 0.1 micron Millipore© membrane filter was used for each water sample. A portion of the filtered water sample was then diluted to a proper dilution factor and tested using an Industrial Test Systems, Inc. Quick™ Arsenic Test Kit (part number 481396). A separate sample was then passed through a speciation cartridge which removed As(V) from the water sample leaving only As(III) in the solution. The As(III) solution was also then diluted to a proper dilution factor and tested using an Industrial Test Systems, Inc. Quick™ Arsenic Test Kit (part number 481396). The test kit contains 3 reagents which reduce inorganic arsenic to arsine gas. A mercuric bromide test strip is used to measure the arsine gas concentration and produces a yellow-brown color which is matched to a calibrated color chart in order to obtain a quantitative measure of arsenic in the water sample. Each UNESCO water batch was also tested with the kit as a control to determine how much arsenic was truly removed from each batch experiment. For a more accurate reading of concentration, samples are sent to a local Berkeley industrial laboratory, Curtis & Tomkins, Inc., for testing using ICP-MS.

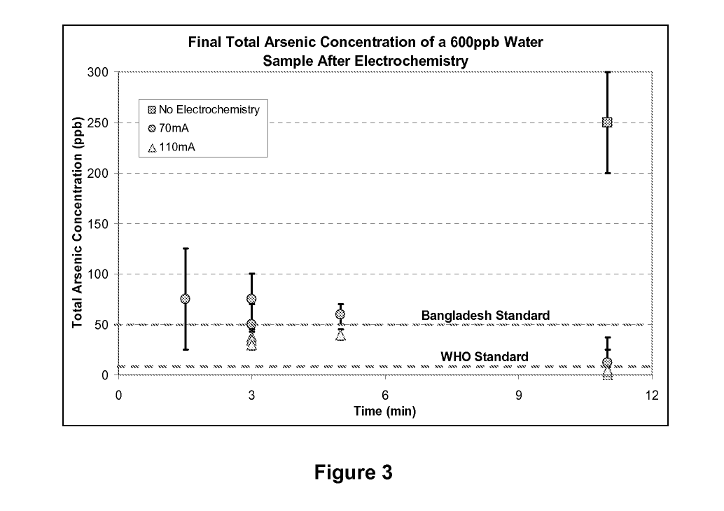

All concentrations and results presented in FIGS. 2 and 3 were measured using the Quick™ Arsenic Test Kit. Results in all other figures were obtained using Inductively coupled plasma mass spectrometry (ICPMS). FIG. 2 presents the results of 12 experiments. It shows the total percentage of arsenic removal when 2 currents were applied for varying amounts of time and after the water sample was stirred for 60 minutes. It can be seen that when no current was applied to the electrodes sitting in the water sample for 11 minutes, the rate of removal was below 58%. However, once a 70 mA or 110 mA current was applied for just 3 minutes, the rate of removal went above the water quality standard for Bangladesh, ranging from 92 to 93%. When 70 mA was applied for 11 minutes, the rate of removal ranged from 92 to 98%, bringing the sample above Bangladesh's standard and within range of the WHO standard. A current of 110 mA removed 98-100% of the total arsenic in the water sample. From these results, it can be seen that applying a current to the electrodes increases the rate of removal by a high percentage. Error bars are dependent on the dilution factor used for each test performed as well as the error of the Quick™ Arsenic Test Kit.

FIG. 3 shows the concentration in ppb (μg/L) of the total arsenic from the 12 experiments above. When no current was applied to the electrodes in the water sample, the arsenic concentration was reduced to 250 ppb from the initial concentration of 600 ppb. However, once 70 mA was applied for 3 minutes the concentration was reduced to 50-60 ppb, at or within the range of Bangladesh's standard. When 110 mA was applied to the electrodes for 3 minutes, the concentration of total arsenic was reduced to 30-40 ppb. At 11 minutes, 70 mA was able to reduce the concentration of the sample to 12.5 ppb. This indicates that if the current was applied for a slightly longer period of time, the WHO standard could be reached using 70 mA. When 110 mA was applied for 11 minutes the concentration was reduced to 0-12.5 ppb, essentially removing all or most of the arsenic from the water sample.

Applying 110 mA for 11 minutes gave us results ranging from 98-100% of total arsenic removal. The longer a current is applied, the more significant of a removal rate. Also, a higher current removes a higher portion of the total arsenic in the water.

### Example 2

### Electrochemical Cells for Removing Arsenic from Water

Two benchtop electrochemical cells are constructed, each comprising a glass beaker containing a pure iron wire anode (diameter=0.18 cm) coiled into a flattened spiral shape and a copper mesh cathode. The active area of both iron and copper electrodes can range from about 9-150 cm² and about 24-150 cm² copper mesh. The iron wire is tested for iron content by Curtis & Tompkins Lab (Berkeley, Calif.) using EPA preparation procedure 3050B and testing procedure 6010B and can contain 10⁶ mg/kg iron (essentially 100% iron).

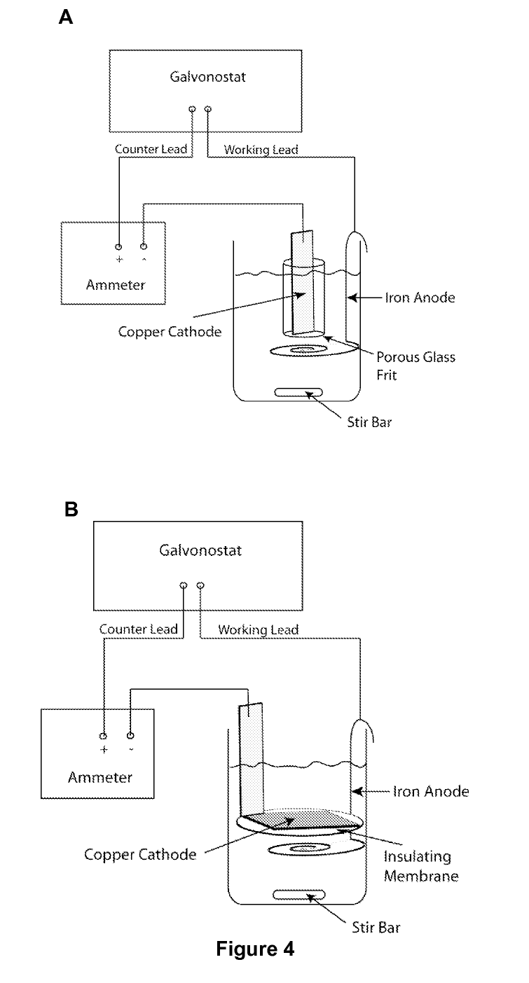

Both cells are hooked up in series with an EG&G model 173 Potentiostat/Galvonostat in galvonostatic mode with either a model 376 logarithmic current converter or model 176 current follower (Princeton Applied Research). This is in series with a Kiethley model 173A or Fluke model 73111 multimeter set to measure current. The setup for each cell is shown in FIG. 4.

The first of the two cell configurations is an 850 mL, separated cathode cell shown schematically in FIG. 4, Panel A. The 1 liter cell beaker has a diameter of 11 cm. The iron electrode, coiled to a diameter of about 10 cm, is submerged to approximately 4 cm above the beaker bottom to make room for a magnetic teflon-coated stir bar. A Schott filter, comprising a glass beaker (diameter=4.3 cm) with a porous glass frit bottom (allowing charge, but very little water to pass), placed approximately 2 cm above the anode with the copper cathode placed inside the Schott filter, creating a separated cathode chamber. The top of the Schott filter is held above water level to ensure minimal mixing of the cathodic and anodic solutions. Sample water filled both chambers up to a total volume of 850 mL (approximately 40 mL in the cathode chamber). Separation of the cathode is intended to shield the main treatment volume from the reduction of As(V) to As(III) at the cathode and the pH increase caused by H+ reduction to H₂ gas.

The second cell configuration is a 3 liter, single chamber cell shown schematically in FIG. 4, Panel B. The cell body is a 3.5 L glass beaker with a diameter of 15.3 cm. A flat spiral iron electrode (same shape and material used in the 850 mL, separated cathode cell) is submerged ⅙ of the total water height (13 cm from the bottom), with the square copper mesh electrode placed flat on top. Two layers of refurbished polyvinylidene fluoride hydrophilic membranes with 0.1 μm pore size (Millipore) were placed between the two electrodes for insulation, leading to an electrode separation of 0.05-0.5 cm (range varied as the iron electrode coil was not completely flat).

### Example 3

### Removing Arsenic from Synthetic Bangladesh Groundwater

A reproducible protocol for ECAR treatment was developed. Synthetic Bangladeshi groundwater (i.e. constituted in the laboratory to have ionic concentrations found in Bangladesh) was developed using two distinct recipes, each containing 600 μg/L arsenic (greater than 98% of the wells in Bangladesh, including equal amounts of As(III) and As(V).

The first recipe closely followed Petrusevski et al. (Aqua—J. Water Supply: Res. Tech. 51(3):135-144, 2002) (hereby incorporated by reference), herein called synthetic water batch recipe 1 (SWBR-1) and was used in batch tests to measure arsenic removal for current densities 0.07-1.1 mA/cm² as a function of time and charge density (charge per liter). These tests verified the ability of EC to reduce arsenic below the WHO limit of 10 ppb and determined the reproducibility of our water treatment protocol. Similar to Kumar, et al. (Kumar, P. R., Chaudhari, S., Khilar, K. C., Mahajan, S. P. “Removal of Arsenic from Water by Electrocoagulation.” Chemosphere 55(9):1245-1252, 2004) (hereby incorporated by reference) we found that charge density (also called charge loading) rather than current density was a controlling factor on arsenic removal within this range. However, as a greater charge density can be reached in a shorter time at a higher current density, removal may be faster at a higher current density. The second synthetic groundwater recipe, herein called synthetic water batch recipe 2 (SWBR-2), was more realistic than the first, closely following the average values of key ions known to interfere with arsenic adsorption onto iron (hydr)oxides (primarily Silicate, Phosphate, and Sulfate). This recipe was used in batch tests to determine the minimum charge per liter necessary for arsenic removal to 10 ppb in Bangladesh, as well as to extend the current density range to 0.02-30 mA/cm² to look for differences in removal efficiency.

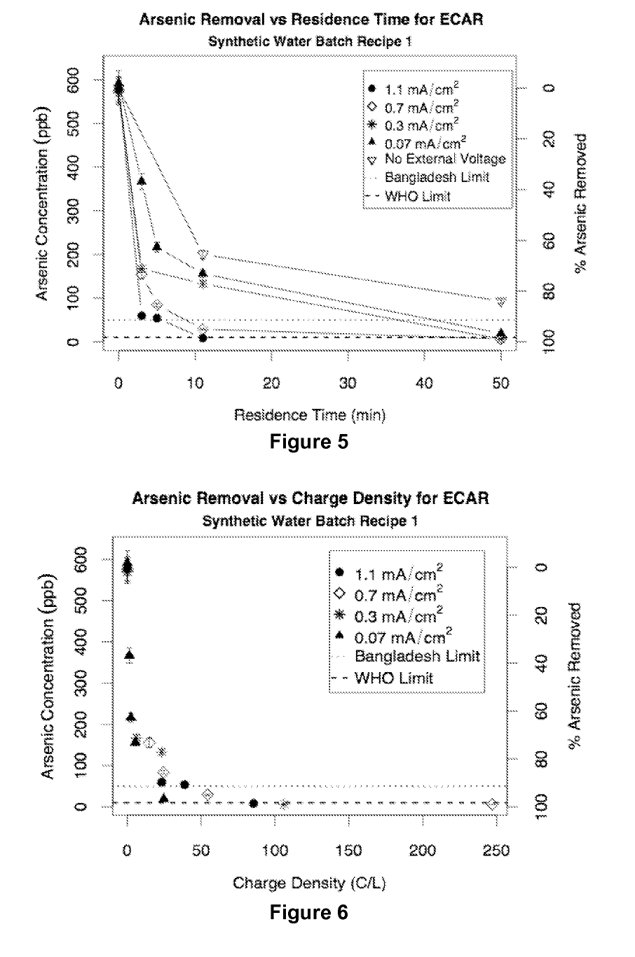

Results from the first set of batch tests using SWBR-1 demonstrate the ability of ECAR to reduce arsenic levels from 580 ppb to below the WHO limit within 50 minutes or less processing time (followed by 60 minutes of mixing) for current density within the range 0.30-1.1 mA/cm² and below 20 ppb (97% arsenic removal) within 50 min or less processing time (followed by 60 minutes of mixing) for current density 0.07 mA/cm² (FIG. 5). For current density 0.30-1.1 mA/cm² the final arsenic after 50 minutes residence time (followed by 60 minutes of mixing) was less than 6 ppb (99% arsenic removal). A trend is seen in which the WHO limit of arsenic is reached after less processing time for higher current density. Final arsenic concentrations for identical experiments with no external voltage applied were 200 ppb (65% arsenic removal) after 11 minutes of residence time (followed by 60 minutes of mixing) and 93 ppb (84% arsenic removal) after 50 minutes of residence time (followed by 60 minutes of mixing) Thus external voltage is required to reach the WHO limit of 10 ppb or the Bangladesh limit of 50 ppb within 50 minutes or less processing time when initial arsenic concentrations are greater than 580 ppb.

Results from the first set of batch tests demonstrate the ability of ECAR to reduce arsenic concentrations from 580 ppb to below the WHO limit of 10 ppb (99% arsenic removal) in SWBR-1 after a charge density of 70 C/L is applied (FIG. 6). No effect of current density on the minimum required charge density is seen in the range of 0.3-1.1 mA/cm². The removal rate as a function of charge density for 0.07 mA/cm² suggests that the WHO limit may be reached after a charge density of less than 50 C/L, however tests were only performed up to 25 C/L (resulting in 19 ppb arsenic), so more data is necessary to make this inference.

Results from the second set of batch tests using SWBR-2 demonstrate the ability of ECAR to reduce arsenic levels below the WHO limit of 10 ppb (99% arsenic removal) for all current densities less than 5 mA/cm² using a charge of 150 C/L). The trend also suggests that arsenic levels could be reduced to below the WHO limit for current density 5-100 mA/cm² if more charge density is applied through a longer processing time. Notably, they also imply that extremely low current densities (such as 0.02 mA/cm²) are more efficient, requiring only ⅙ of the charge to remove the same amount of arsenic (black solid line in). See FIG. 6.

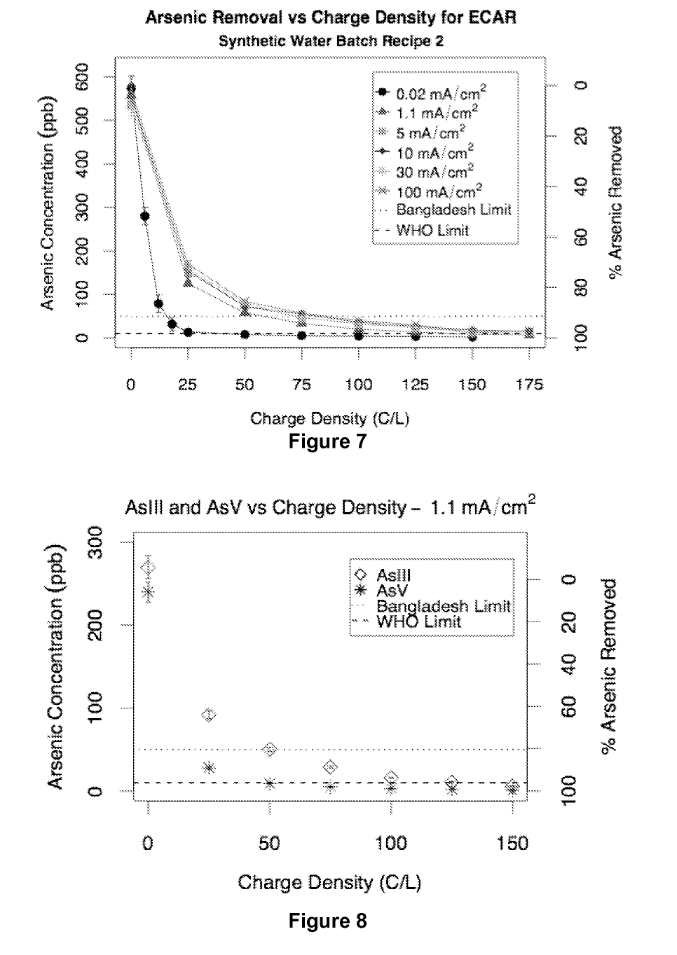

Attached is a plot (FIG. 7) that shows the residual arsenic levels in synthetic Bangladeshi water (SBWR-2) treated at different current densities. Data for 0.02 mA/cm² (the black line) shows levels below the WHO limit (10 ppb) after only 25 C/l of charge has been passed. This current density is lower than what was previously thought to be effective. In addition, higher current densities require up to 150 C/l of charge to be passed before the levels reach <10 ppb.

The electrochemical oxidation of As(III) to As(V) is a significant side-reaction that may occur at the anode during the electrochemical process. This reaction will allow the removal of both forms of arsenic rather than just the removal of As(V). In an electrochemical cell, oxidation of As(III) may occur at the anode and reduction of As(V) may occur at the cathode. Net oxidation of As(III) may occur through oxidation of As(III) at the anode if the cathode is separated from arsenic in solution. Net oxidation of As(III) may also occur with no separation between the arsenic in solution and the cathode if As(III) is oxidized to As(V) at the anode and subsequently forms a complex with iron (hydr)oxide or other sorbates in solution before reaching the cathode (where reduction back to As(III) can occur). Attached is a plot (FIG. 8) showing the As(III) and As(V) concentrations in SWBR-2 water treated at 1.1 mA/cm² (with a mixing time of 60 minutes) as a function of charge density. As(V) concentrations are reduced from 220 ppb to less than 10 ppb after only 50 C/L passed. As(III) concentrations were reduced from 280 ppb to less than 10 ppb after 150 C/L. Both As(V) and As(III) concentrations are reduced to levels below 10 ppb. As(III) removal via EC is higher than the removal seen through coprecipitation with Fe(III) salts (Kumar et al, 2004).

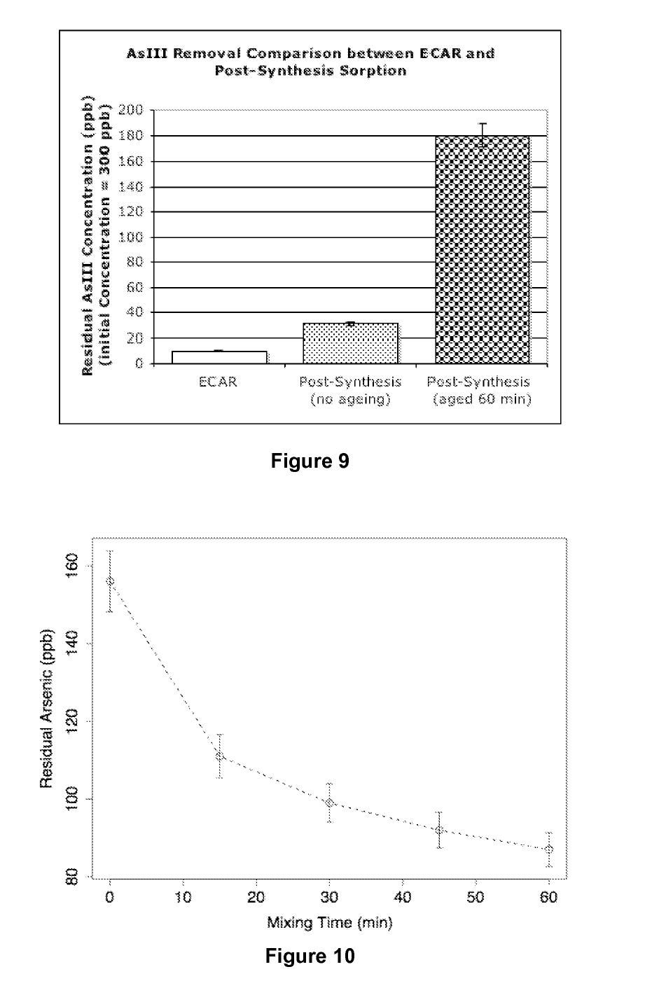

The greater removal capacity of As(III) seen in ECAR compared to other methods, such as coprecipitation with Fe(III) salts, could be the result of one or more of the following mechanisms: (1) net amounts of As(III) oxidize to As(V) in the ECAR process which subsequently bind to iron (hydr)oxides, (2) the affinity of iron (hydr)oxides produced in ECAR for As(III) is higher than the affinity of iron (hydr)oxides produced through coprecipitation with Fe(III) salts for As(III), and/or (3) ECAR enhances the coagulation and aggregation of As(III)-iron (hydr)oxide complexes relative to other methods, allowing for more complete removal via filtration. The measure the affinity of iron (hydr)oxides produced in ECAR for As(III) independently of ECAR-induced oxidation to As(V) and/or ECAR-enhanced coagulation or aggregation, removal efficiencies were measured in systems containing iron (hydr)oxides produced by ECAR before coming into contact with arsenic in solution. Experiments in which the adsorbent is synthesized before coming into contact with the adsorbate are termed post-synthesis adsorption experiments. In these post-synthesis sorption experiments, the adsorbent—iron (hydr)oxides—were created using the second batch test procedure in SWBR-2 water without any arsenic, with a current density of 5 mA/cm² and a charge density of 175 C/L. 600 ppb of arsenic (comprised of half As(V) and half As(III)) was added after 0 minutes of ageing the synthesized iron (hydr)oxides. In a separate experiment, 600 ppb of arsenic (comprised of half As(V) and half As(III)) was added after 60 minutes of ageing the synthesized iron (hydr)oxides. FIG. 9 compares the final As(III) concentration in solution, including results from one standard ECAR treatment at 5 mA/cm² and 150 C/L including 60 minutes of mixing and filtration (left bar), and the final As(III) concentration in solution after exposure to post-synthesis iron (hydr)oxide products for 60 minutes of mixing followed by filtration (middle and right bars). The final arsenic concentration is lowered from 300 ppb to 10 ppb using EC (96% removal), but only to 31 ppb (90% removal) using post-synthesis iron (hydr)oxides and 180 ppb (39% removal) using aged post-synthesis iron (hydr)oxides. While ECAR-generated iron (hydr)oxides show some affinity for As(III), removal capacity using ECAR is higher, implying that either net oxidation or enhanced coagulation and aggregation caused by the ECAR treatment are important effects for reducing As(III) concentrations below the WHO limit. Also demonstrated is a trend for decreased As(III) removal with increased aging of post-synthesis iron (hydr)oxides.

Since As(III) is much more difficult to remove using conventional adsorption methods and more toxic than As(V), it is quite advantageous to oxidize As(III) to As(V) in order to remove the ion from the water. Most conventional methods of removing arsenic from drinking water are unable to remove As(III) and most of the ion usually remains in the drinking water. Kumar et al. (Chemosphere 55(9):1245-1252, 2004) (hereby incorporated by reference) found that As(III) removal by coprecipitation with Fe(III) salts is quite less compared to As(V). However, the use of electrochemistry not only is able to remove nearly 100% of one form of arsenic occurring in the water, As(V), it is also potentially able to remove the second form, As(III), through conversion of As(III) to As(V). This oxidation of As(III) makes this removal process much more effective and efficient to implement on a mass scale.

A batch test using SWBR-2 water, a current density of 1.1 mA/cm̂2, and charge density of 100 C/L was used to measure the effect of mixing time (time after current has been turned off) on final arsenic concentration. FIG. 10 shows the final arsenic concentration for mixing times of 0-60 minutes, clearly showing a reduction in final arsenic concentration with increased mixing time (in this case, final arsenic concentration is reduced an additional 44% after 60 minutes of mixing). Allowing the solution to settle for 22.25 hours before filtration resulted in a final arsenic concentration of 15 ppb. This test demonstrates a reduction in final arsenic concentration of EC effluent.

### Example 4

### Removing Arsenic from Water

Arsenic analysis and arsenic speciation. All reported arsenic concentrations were measured using Inductively Coupled Plasma Mass Spectroscopy (ICMS) provided by Curtis & Tompkins, Ltd. (Berkeley, Calif.) Samples for ICPMS were transported to Berkeley in plastic 15-mL vials that had been radiation sterilized by the vendor (BD Biosciences; San Jose, Calif.). Every case digested samples appeared clear and free of precipitate.

Tube well water sample collection and storage. Thirteen tube wells in Bangladesh were sampled, twelve with high arsenic concentrations (Asₜₒₜ>100 μg/L). Samples were collected from 5 villages in Jhikargachha Upazila and Abhaynagar Upazila (both of Jessore district in Khulna division) and one village from Sonargaon Upazila, just outside of Dhaka. Seven samples were later used in testing, including at least one sample from each village visited.

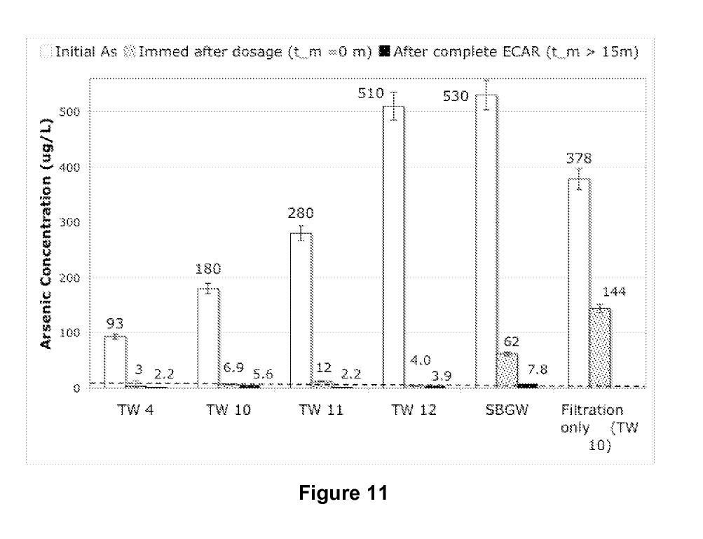

Sealed 1-liter tube well water samples were opened 8-22 days after collection and treated using ECAR at a current density of 0.75-1.1 mA/cm² and a total charge passed of 85-175 C/L (depending on initial arsenic concentration and regional tubewell data on relevant interfering ions). Water from one tubewell (TW 10) was filtered without ECAR treatment to determine the arsenic removal capacity of the naturally occurring iron in the water, In all samples, ECAR reduced the arsenic content below the WHO limit of 10 μg/L (see FIG. 11). This demonstrated the ability of EC to reduce both high and low arsenic levels in different regions of Bangladesh to below the WHO limit.

ECAR performance in real groundwater. ECAR treatment reduced the arsenic concentration in real Bangladesh groundwater to less than the WHO recommended limit (Asₜₒₜ<10 μg/0 in every case (FIG. 11), removing 97-99% of the total initial arsenic. Pre-treatment arsenic concentrations ranged from 93-510 μg/L, covering the concentrations found in >96% of contaminated tube wells in Bangladesh. Dosages, current processing times, and mixing time varied between tests to ensure removal to below the WHO limit in every case (and therefore prove that ECAR is capable of reducing arsenic to below the WHO limit). Dosages were purposely high to ensure complete removal. From FIG. 11, we see that final arsenic concentrations for tube well samples treated with ECAR were comparable to, and slightly smaller than, final arsenic concentrations for synthetic groundwater (SWBR-1). The arsenic concentration immediately after dosing (designated by t_{M}=0 min in FIG. 11) was already below the WHO limit for TW 4, 10, and 12 and close for TW 11, while for synthetic groundwater the concentration is above the less stringent limit of 50 μg/L.

It is clear from FIG. 11 that coprecipitation using the natural iron in the well water is insufficient on its own to reduce arsenic to below either the WHO or Bangladesh limits in TW 10. Filtration alone reduced the total arsenic from 378 μg/L to 144 μg/L, a reduction of only 62%. It is difficult to compare this directly to ECAR, since ECAR treatment on the same tube well used the residual arsenic left in the water after some iron precipitation and settling occurred, resulting in a lower initial arsenic concentration (180 μg/L compared to 378 μg/L). However, TW 10 demonstrates that an initial settling period and filtration step before ECAR could lower the initial arsenic, allowing ECAR treatment with a lower dosage.

### Example 5

### Arsenic Removal in Synthetic Bangladesh Groundwater Using Different Initial Arsenic Concentrations (300 ppb-3000 ppb)

Method. Batch tests are performed using the cell design as described in Example 2 herein and shown in FIG. 4, panel B. Batch tests are run in synthetic Bangladesh Groundwater following the recipe SWBR-2 as described in Example 3 herein with the exception of arsenic concentration. SWBR-2 water is spiked with equal amounts of As(V) and As(III) such that the total arsenic concentration is Asᵢₙᵢₜ=2800 ppb, 570 ppb, and 270 ppb respectively for subsequent batch tests. All tests are run at a current density of 1.1 mA/cm², an operating current of 110 mA, and a mixing time of 60 minutes. Aliquots are removed every 25 C/L (Coulombs per liter) up to 200 C/L for batch tests at Asinit=570 and 270 ppb, and 400 C/L for the batch test at Asᵢₙᵢₜ=2800 ppb. Processing time is calculated based on the equation Tₚ=q/(J A/V) where q is the charge density or charge loading (in Coulombs/Liter), J is the current density, and A/V is the ratio of active electrode area over treatment volume. Each experiment begins with A/V=0.033 cm⁻¹, which increases slightly over the test as sample aliquots are removed from the treatment volume. All reported arsenic measurements are obtained using inductively coupled plasma mass spectroscopy (ICPMS) performed by Curtis & Tompkins, Ltd. (Berkeley, Calif.).

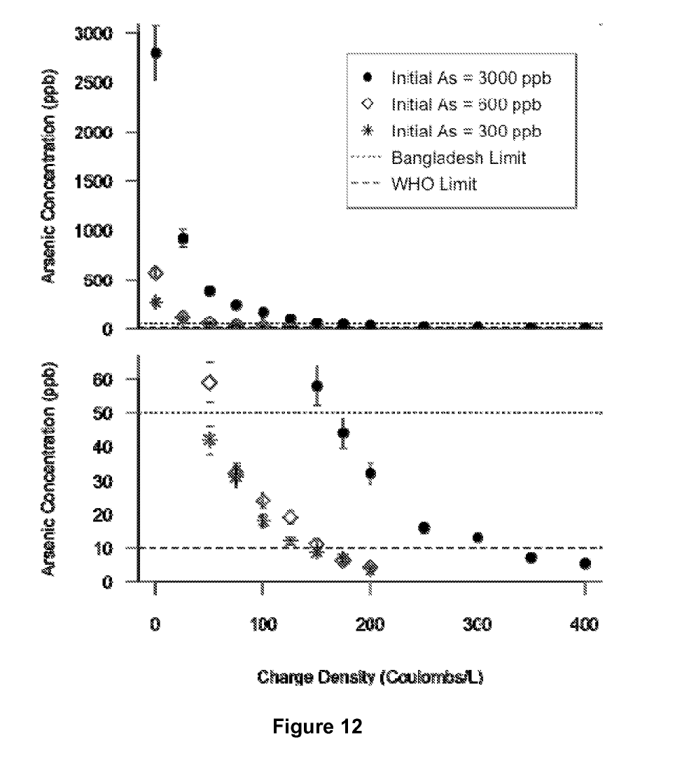

Results. Results shown in FIG. 12 demonstrate the ability of ECAR to reduce initial concentrations of total arsenic (comprising both As(III) and As(V)) up to 2800 ppb to below both the Bangladesh legal limit (50 ppb) and the World Health Organization (WHO) maximum recommended limit (10 ppb) in synthetic Bangladesh groundwater. Final arsenic concentrations for batch tests with initial arsenic=2800, 570, and 270 ppb are 5.4, 4.3, and 3.4 ppb respectively, corresponding to a removal of 99.8%, 99.2%, and 98.7%. A trend is seen in which a higher initial arsenic concentration requires a higher charge density to reach the Bangladesh and WHO limit.

### Example 6

### Arsenic Removal from Water Using Sushi Prototype

Method. The prototype comprises the following: The dosing chamber of the “Sushi” prototype comprises of a cylindrical volume (10 cm diameter, 24 cm length) with a water-tight inlet and outlet hose attachment. A valve attached to the outlet hose controls the flow rate through the device. Filling the inner cylindrical volume is the Sushi electrode assembly, which comprises of two long sheets of flexible (0.05 mm thick) carbon steel (anode and cathode) sandwiching a plastic mesh garden fence (2.5 mm thick) material (mesh spacing=1 inch) rolled into a spiral shape (similar to a sushi roll). The resulting electrode assembly had an active electrode area of about 1040 cm² and an electrode spacing of 2.5 mm. Electrode leads are cut from the same material as the electrode and powered by a 12V car battery via a small constant current circuit.

Field Test 1. All reported arsenic measurements for Cambodia samples are obtained using inductively coupled plasma mass spectroscopy (ICPMS) performed by Curtis & Tompkins, Ltd. (Berkeley, Calif.). All reported arsenic measurements for Bangladesh samples are obtained using Atomic Absorption Spectroscopy with a graphite furnace (AAS).

Nine arsenic-contaminated tube wells are chosen from the three communes Preak Russei, Dei Edth, and Preak Aeng in Kandal Province, Cambodia (initial arsenic concentrations 80-750 ppb). Tube well water is sampled at the well-head and stored in translucent plastic water bottles for up to 3 weeks. Immediately before ECAR treatment, water samples are decanted and the initial arsenic concentration is measured. The sample water is then dosed using the ECAR Sushi prototype described above using a current density of 1.06 mA/cm2, an operating current of 1.11 A, and a mixing time of 0 min. The flow rate is adjusted to 18 L/hr, resulting in a total charge density of 221 C/L. After dosing, water is gravity fed through an 11-micron pore size filter and the filtrate is tested for final arsenic concentration.

Field Test 2. Two arsenic-contaminated tube wells are chosen from the village of Dhingaghanga near Dhaka, Bangladesh (TW 1 and TW 2, with initial arsenic 200 and 250 ppb respectively). Tube well water is sampled at the well-head and stored in plastic containers for about 120 hours. Immediately before ECAR treatment, water samples are decanted and the initial arsenic concentration is measured. The sample water is then dosed using the ECAR Sushi prototype described above using a current density of 0.96 mA/cm², an operating current of 1.0 A, and a mixing time of 60 min. Total charge density is 456 C/L for TW 1 and 366 C/L for TW 2. After mixing, water is either filtered directly through a 0.1 micron pore size filter (achieved via vacuum filtration) or allowed to settle for 2 days in a beaker and decanted from the top 10 cm (no filtration).

Results from Field Test 1. Table 3 lists the initial (immediately before ECAR treatment) and final (after ECAR treatment) arsenic concentrations for the 9 tube well water samples from Kandal Province, Cambodia. For initial arsenic concentrations of 80-750 ppb, the final arsenic concentration is below the WHO limit of 10 ppb in every case. In 8 cases, the final arsenic concentration is below 5 ppb, and in 6 cases, no arsenic is detected in the final sample (reporting limit for ICPMS=1 ppb). This demonstrates that ECAR treatment is very effective in typical groundwaters of Kandal Province, Cambodia. It also demonstrates the effectiveness of the Sushi prototype design under field conditions.

TABLE 3
Arsenic concentrations before (initial) and after (final)
ECAR treatment for tube well water samples taken from
select communes in Kandal Province, Cambodia.

| | Initial Arsenic | Final Arsenic |
|---|---|---|
| Tube Well Location and | Concentration | Concentration |
| Number | (ppb) | (ppb) |
| Dei Edth - 1 | 130 | 3.9 |
| Dei Edth - 2 | 370 | 3.1 |
| Dei Edth - 3 | 280 | ND |
| Preak Aeng - 1 | 80 | ND |
| Preak Aeng - 2 | 210 | ND |
| Preak Aeng - 3 | 260 | ND |
| Preak Russei - 1 | 530 | 7.4 |
| Preak Russei - 2 | 760 | ND |
| Preak Russei - 3 | 750 | ND |

ND refers to “not-detected,” with a reporting limit of 1 ppb.

Results of Field Test 2. Table 4 lists the initial (immediately before ECAR treatment) and final (after ECAR treatment) arsenic concentrations for the 2 tube well water samples from Dhingaghanga village near Dhaka, Bangladesh. For initial arsenic concentrations of 200-250 ppb, the final arsenic concentration is below the WHO limit of 10 ppb in both cases (final arsenic=8 and 7 ppb respectively). This demonstrates that ECAR treatment is very effective in typical groundwaters near Dhaka, Bangladesh. It also demonstrates the effectiveness of the Sushi prototype design under field conditions.

Table 4 shows 2 days of quiescent settling in place of costly 0.1 micron filtration is sufficient to reduce arsenic to less than the Bangladesh limit of 50 ppb, but not the WHO limit of 10 ppb. Final arsenic concentrations using this method are 12 and 16 ppb for TW 1 and TW 2, respectively. The longer settling time, or the addition of a coagulant such as alum, could result in a final arsenic concentration below the WHO limit of 10 ppb.

TABLE 4
Arsenic concentrations before (initial) and after (final) ECAR
treatment for tube well water samples taken from Dhingaghanga
village near Dhaka, Bangladesh. Also shown (far right column)
is the final arsenic concentration after two days of quiescent
settling in place of 0.1 micron filtration.

| | | | Final Arsenic |
|---|---|---|---|
| | Initial Arsenic | Final Arsenic | Concentration - 2 |
| | Concentration | Concentration | day settling only |
| Tube Well | (ppb) | (ppb) | (ppb) |
| TW 1 | 200 | 8 | 12 |
| TW 2 | 250 | 7 | 16 |

### Example 7

### Arsenic Removal from Synthetic Bangladesh Groundwater Using a 20 L Parallel Plate Prototype

Method. Batch tests are run in synthetic Bangladesh Groundwater following the recipe SWBR-2 described in Example 3 herein. All reported arsenic measurements are obtained using inductively coupled plasma mass spectroscopy (ICPMS) performed by Curtis & Tompkins, Ltd. (Berkeley, Calif.).

The 20 L parallel plate prototype (hereafter called the “20 L prototype”) comprises of a rectangular glass aquarium (25×47×29 cm) acting as the dosing and mixing tank. Plastic spacers support between 6-22 steel plate electrodes (each plate is 21.5×31×0.069 cm) spaced 2 or 8 cm apart. A small gap (approx 2 mm) is always present between the plates and the glass wall of the aquarium (this is important for solution agitation). There is a larger gap, of approximately 5 cm, between the plate assembly and the bottom of the tank Every other plate is connected in series, forming a steel anode and steel cathode, each comprising of half of the plates. The anode and cathode are in turn connected to the positive and negative ends of either (1) a 12-Volt car battery connected to a constant current circuit, or (2) a EG&E model 173 Potentiostat/Galvonostat operating on galvonostatic mode.

During the dosing stage, one of two methods may be employed to agitate the solution. The first is aeration, in which three small pipes run along the bottom of the tank (below the electrode assembly), each containing a series of punched holes. An air compressor is attached to the pipes, producing bubbles of air that rise between the electrode plates to agitate the solution. The second possible method of agitation is through the use of two small impellers (in place of the aeration pipes). The impellers are arranged such that the blades fall between the electrode assembly and the tank bottom. The impellers are rotated using modified commercial hand mixers or small DC motors. The impellers can rotate at three different speeds—high, medium, and slow—depending on the hand mixer setting, or the voltage supplied to the DC motors.

The batch procedure used to remove arsenic from water using the 20 L prototype comprises: (1) 20 liters of arsenic-contaminated synthetic Bangladesh groundwater is poured into the prototype, (2) the electrode assembly is submerged into the water, (3) agitation begins by either (a) starting the air compressor (in the case of aeration) or (b) turning on the impellers (in the case of impeller agitation), (4) dosing begins by applying a constant current to the anode and cathode for some amount of time, tₚ, (5) the electrode assembly electrode is removed (agitation continues) for post-electrolysis mixing time, tₘᵢₓ, (6) solution is filtered using a glass vacuum filter apparatus with a 0.1 micron Millipore membrane. Aliquots are removed immediately before, during, and after, full treatment for arsenic testing.

Batch tests performed with 20 L prototype. Several series of batch tests are run using the 20 L prototype in SWBG-2 water. Each batch test in a series is identified below by the following operating conditions: current density, j, total charge density, qₜₒₜ, processing (or residence) time, tₚ, post-electrolysis mixing time, tₘ, total number of electrode plates, n, plate separation, d, agitation method—aeration or impeller, and impeller speed—F (fast), M (medium), S (slow), NA (not applicable; i.e. if no impellers were used).

Series 1: Comparison of agitation method, agitation speed, and mixing time. Four batch tests are performed in the 20 L prototype to access the effect of different agitation methods (impeller versus aeration) during dosing and the effect of impeller speed. In one batch test, impellers are used at a fast speed. In a second batch test, impellers are used at a medium speed. In a third batch test, impellers are used as a slow speed. In a fourth batch test, no impellers are used, and aeration is used to agitate the solution. For each batch test (excluding fast speed impellers), a sample is removed after 0 minutes of mixing (tₘ=0) and then after 30 minutes of mixing (at tₘ=30 min). Full operating conditions are given in Table 5.

TABLE 5
Series 1 operating conditions

| | j | qₜₒₜ | tₚ | tₘ | | d | Agitation | Agitation |
|---|---|---|---|---|---|---|---|---|
| Name | (mA/cm²) | (C/L) | (min) | (min) | n | (cm) | Method | Speed |
| Fast | 0.079 | 112 | 70 | 0, 30 | 24 | 2 | Impeller | F |
| Impellers | | | | | | | | |
| Medium | 0.083 | 112 | 70 | 0 | 22 | 2 | Impeller | M |
| Impellers | | | | | | | | |
| Slow | 0.083 | 112 | 70 | 0, 30 | 22 | 2 | Impeller | S |
| Impellers | | | | | | | | |
| Aeration | 0.080 | 109 | 70 | 0, 30 | 22 | 2 | Aeration | NA |

Series 2: Comparison of plate configuration and number of plates. Three batch tests are performed in the 20 L prototype to access the effect of using a different number of electrode plates, and of locating the plates in different configurations. In one configuration, 6 plates are placed in the center of the 20 L prototype volume, spaced 2 cm apart. In a second configuration, 6 plates are placed uniformly throughout the full 20 L prototype volume, spaced 8 cm apart. In the third configuration, 22 plates are placed uniformly throughout the full 20 L prototype volume, spaced 2 cm apart. See Table 6.

TABLE 6
Series 2 operating conditions

| | j | qₜₒₜ | tₚ | tₘ | | d | Agitation | Agitation |
|---|---|---|---|---|---|---|---|---|
| Name | (mA/cm²) | (C/L) | (min) | (min) | n | (cm) | Method | Speed |
| 6 plates | 0.30 | 107 | 70 | 0 | 6 | 2 | Aeration | NA |
| (center) | | | | | | | | |
| 6 plates | 0.29 | 107 | 70 | 0 | 6 | 8 | Aeration | NA |
| (full volume) | | | | | | | | |
| 22 Plates | 0.08 | 109 | 70 | 0 | 22 | 2 | Aeration | NA |
| (full volume) | | | | | | | | |

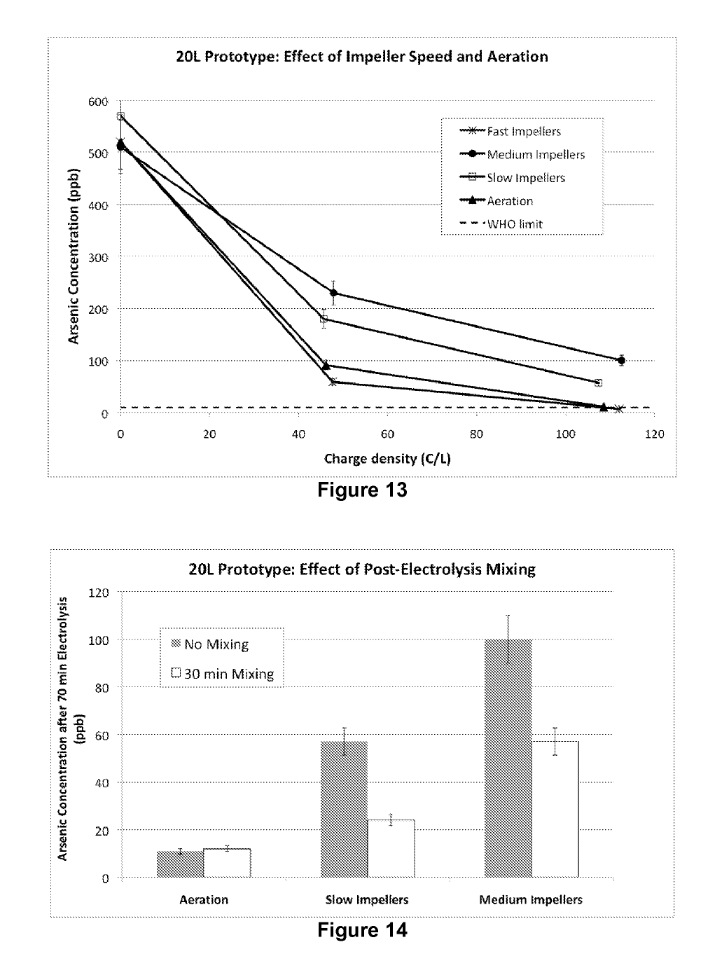

Results. FIG. 13 shows the arsenic concentration as a function of charge density (in Coulombs/L) for batch tests in the 20 L prototype using different methods of agitation. FIG. 13 demonstrates that, when agitation is performed by aeration or impellers running at a fast speed, the 20 L prototype is able to reduce approximately 520 ppb of arsenic in synthetic Bangladesh groundwater, including As(III) and As(V) in equal proportions, to levels consistent with or less than the WHO limit (10 ppb). The total charge density required to reach the WHO limit for the 20 L prototype operating at a current density near j=0.08 mA/cm² is approximately 110 C/L.

FIG. 13 also shows that the charge density required to reach the WHO limit is similar for both aeration and impellers at a fast speed. Thus these two methods of agitation are interchangeable in terms of the arsenic removal performance of the 20 L prototype.

FIG. 13 further shows that, at a charge density near 112 C/L, arsenic has not been reduced to the WHO limit for agitation with slow or medium speed impellers. Final arsenic was 57 and 100 ppb for slow and medium speed impellers respectively. The fact that slow and fast speed impellers both outperform medium speed impellers suggests that arsenic removal performance is not linear with agitation speed, and some speeds may cause interference with arsenic removal. FIG. 13 suggests that faster speeds above a certain threshold produce the best arsenic removal performance, and are required to reach the WHO limit with less than 112 C/L passed.

FIG. 14 shows the additional benefit gained from adding a 30 min post-electrolysis mixing step after dosing. In the case of aeration as an agitation method, additional mixing does not increase the arsenic removed significantly. This is perhaps due to the rapid increase in dissolved oxygen added to the water due to the air bubbles. If the key benefit of the mixing stage involves allowing time for dissolved oxygen in solution to increase, then aeration during dosing could make this step unnecessary. In the case of slow speed and medium speed impellers, additional mixing clearly increases the arsenic removal (decreasing the final arsenic concentration). However, the increase in arsenic removal after 30 min of mixing is not enough to reduce arsenic levels to the WHO limit of 10 ppb. These results suggest that an additional mixing stage will be most beneficial when impellers are used, and least beneficial when aeration is used.

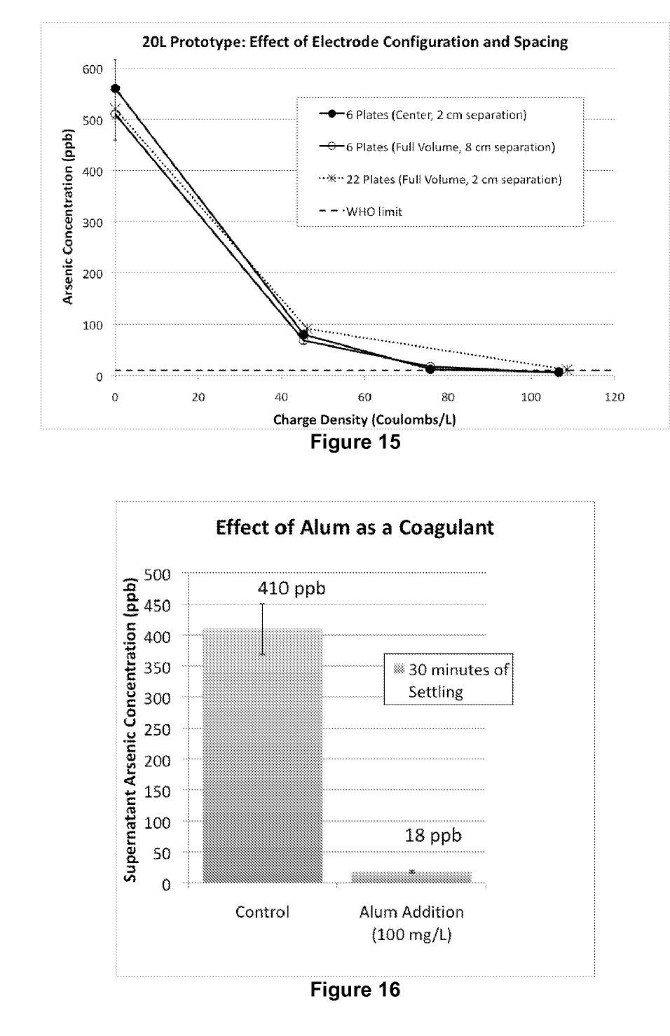

FIG. 15 shows the arsenic concentration as a function of charge density (in Coulombs/L) for batch tests in the 20 L prototype using a different number of plates in different plate configurations. Significantly, FIG. 15 shows that there is no loss in arsenic removal performance when 6 plates uniformly distributed over the full treatment volume are instead concentrated into 6 plates at the center of the treatment volume. This indicates that parallel plates can be configured in a concentrated location without any performance loss. FIG. 15 also shows little to no performance loss when 22 electrode plates are reduced to 6 electrode plates. This indicates that arsenic removal performance is independent of the number of plates in a range of 6-22 (even only).

### Example 8

### Enhancing the Settling Rate of ECAR-Generated Particles

Method. Batch tests are run in synthetic Bangladesh Groundwater following the recipe SWBR-2 described in Example 3 described herein. All reported arsenic measurements are obtained using inductively coupled plasma mass spectroscopy (ICPMS) performed by Curtis & Tompkins, Ltd. (Berkeley, Calif.). Batch tests are performed using the cell design described in Example 2 herein and shown in FIG. 4, panel B. In each case, aliquots are removed from the batch after ECAR dosing and mixing (operating conditions were specific to each test, and given below). Aliquots are then placed in beakers and appropriate coagulant is added in appropriate amounts (specific to each test, given below) followed by a rapid stir for 30 seconds to 2 minutes. The beakers are then allowed to sit and settle (starting at t=0 min). After some settling time, the supernatant solution is sampled 2 cm below the surface and the supernatant arsenic concentration measured via ICPMS. Initial pH for batch tests is pH=6.6-7.4. Four batch tests are performed, with each batch test producing several settling beakers to which different levels of coagulant are added. For each batch test, a control beaker is kept with no additional coagulant. Control beakers are samples at the same times as the coagulant beakers.

In one batch test (called “Alum”), a beaker with 100 mg/L Alum (reagent grade Aluminum sulfate octadecahydrate) is compared to a control beaker (no coagulant added). In one batch test (called “Polyelectrolyte and Polyacrylamide”), four beakers are prepared with 4.6, 10, 27, and 47 mg/L respectively of a polyelectrolyte purchased in Bangladesh under the name “Polyelectrolyte” with no supporting or supplemental information on the contents. One beaker is prepared with 29 mg/L of Polyacrylamide (Pfaltz & Bauer, Inc.), and one beaker is left as a control (no coagulant added). In one batch test (called “Particle Density”), aliquots are removed during dosing at various times corresponding to charge densities of 150, 300, 625, and 130,106 C/L. These charge densities correspond to approximately 1×, 2×, 4×, and 867× the dose needed to reduce arsenic in synthetic Bangladesh groundwater to the WHO limit of 10 ppb. In this case, 150 C/L (1× the dose required to reach the WHO limit) is treated as a control. Using Faraday's law, one can convert from charge density to expected iron density in solution (assuming all charge is used to produce Fe³′ ions at the anode). Previous measurements of ECAR-generated adsorbent show that the ratio of iron to total mass is around 0.44. Using this number, one can estimate the particle density (in mg/L) of ECAR-generated adsorbent, also called sludge, present in each solution. In one batch test (called “NaOH, NaCl, Polyelectrolyte”), NaOH is added to two beakers such that the pH was 8.5 and 10.0 respectively, NaCl is added to two additional beakers in quantities of 0.5 and 20 μg/L respectively, polyelectrolyte (as described above) is added to two additional beakers in quantities of 15 and 37 mg/L respectively, and one beaker at pH 7 is left as a control (no coagulants added). Table 7 shows the batch tests performed with the indicated operating conditions (where j=current density, qₜₒₜ=total charge density, tₚ=current processing time, tₘ=mixing time).

TABLE 7

| | j | qₜₒₜ | tₚ | tₘ |
|---|---|---|---|---|
| Coagulant Added/Test Name | (mA/cm²) | (C/L) | (min) | (min) |
| Alum | 1.1 | 200 | 75 | 0 |
| Polyelectrolyte and | 1.5 | 180 | 60 | 10 |
| Polyacrylamide | | | | |
| Particle Density | 4.3 | 150-130, | 12.5-3645 | 20 |
| | | 106* | | |
| NaOH, NaCl, | 2.0 | 160 | 40 | 10 |
| Polyelectrolyte | | | | |

*qₜₒₜ and tₚ varied with each particle density.

Results. Effect of Alum as a Coagulant. FIG. 16 shows the supernatant arsenic concentration for a control beaker compared to a beaker with 100 mg/L alum added, both after 30 minutes of settling. The difference is remarkable, with alum addition leading to a 96% decrease in supernatant arsenic after 30 minutes. In addition, the low arsenic concentration in the alum beaker (18 ppb) compared to the control (410 ppb) shows that alum does not cause arsenic to desorb from the iron (hydr)oxide particles. Thus alum is an extremely effective coagulant of ECAR-generated iron (hydr)oxide particles, and can be used to enhance ECAR performance.

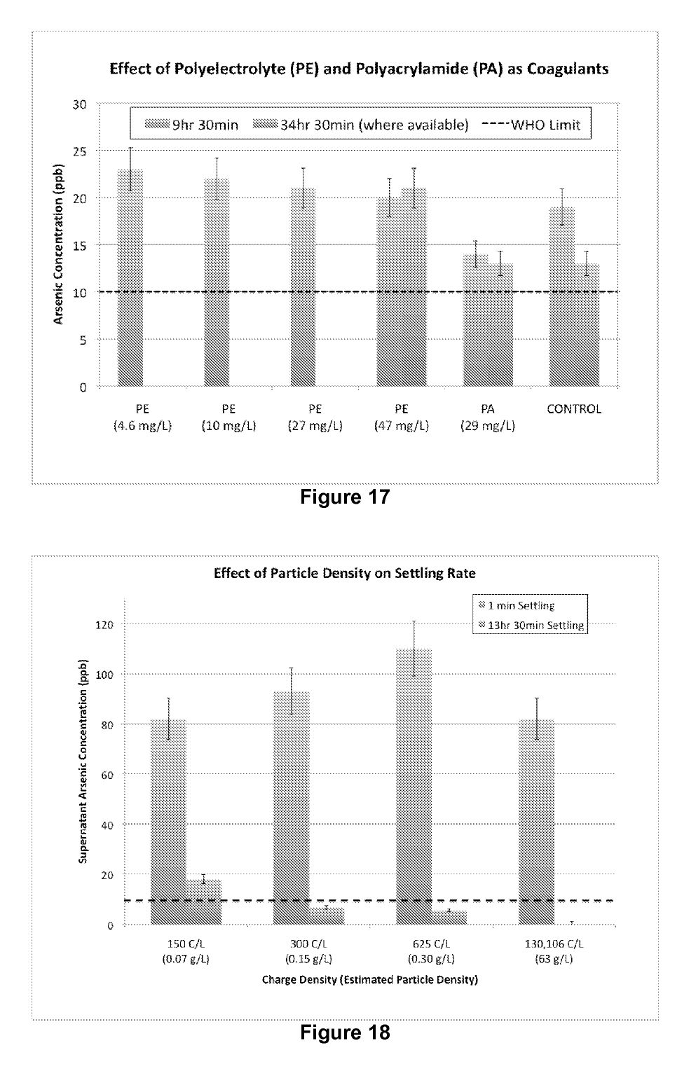

Effect of polyelectrolyte and polyacryamide as a coagulant. A polyelectrolyte available in Bangladesh (labeled only “Polyelectrolyte”) and regent grade polyacrylamide are added to settling beakers in various concentrations (4.6-47 mg/L for polyelectrolyte, and 29 mg/L for polyacrylamide) and compared to a control. FIG. 17 shows the supernatant arsenic concentration in settling beakers after 9 hr 30 min, and in some cases, after 34 hr 30 min of settling. FIG. 17 shows no significant increase in the settling rate at 9 hr 30 min with respect to the control sample for polyelectrolyte at any concentration in the range 4.6-47 mg/L. In the case of 47 mg/L polyelectrolyte, arsenic levels in the supernatant are consistent between 9 hr 30 min and 34 hr 30 min, indicating that the settling has leveled off. In contrast, the control beaker continues to settle, reaching 13 ppb at 34 hr 30 min, compared to 21 ppb with polyelectrolyte. Thus polyelectrolyte in concentrations of 4.6-47 mg/L does not seem to effectively enhance settling rates, and may even decrease settling rates, with respect to no added polyelectrolyte. It is possible that polyelectrolyte could enhance coagulation and settling at higher or lower concentrations than those tested here. Polyacrylamide at concentrations of 29 mg/L increases settling slightly compared to the control by 9 hr 30 min. However, the effect disappears by 34 hr 30 min when both the polyacrylamide and control samples are at 13 ppb arsenic. Thus 29 mg/L polyacrylamide is not a highly effective coagulant. Higher or lower concentrations may be effective.

Effect of particle density on settling rate. It has been noted in previous experiments that a higher charge density tends to result in a faster settling rate. The charge density is directly related to the density of ECAR-generated adsorbent, or sludge, in solution. A higher particle density could, in itself, act as a coagulant by increasing the number of opportunities for any two particles to aggregate in solution. FIG. 18 shows the supernatant arsenic concentration after 1 min and 13 hr 30 min of settling for several different charge densities, ranging from 2× to 867× the charge density required to reduce arsenic to the WHO limit. After 1 min of settling, there is no linear correlation between particle density and supernatant arsenic concentration—the largest arsenic concentration 625 C/L (4× minimal dose). However, after 13 hr 30 min, all charges densities greater than 2× control have significantly lower arsenic concentrations that are already below the WHO limit. In the case of extreme overdosing (130,107 C/L, or 867× the control), the arsenic concentration is effectively zero, or not detected (the reporting limit of ICPMS for this measurement is 1 ppb). This indicates that increasing the charge density dosage, even by a factor of 2, could significantly decrease the settling time required to reach the WHO limit.

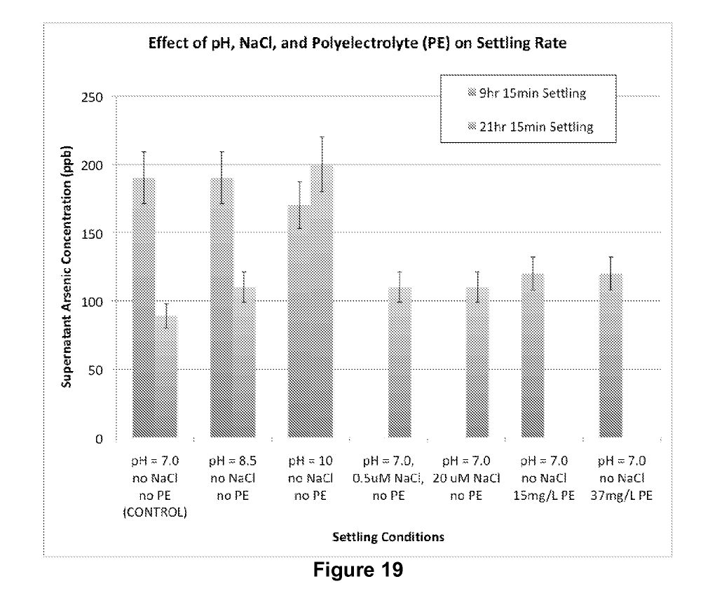

Effect of pH (NaOH), NaCl, and polyelectrolyte on settling rate. FIG. 19 compares the supernatant arsenic concentration after 9 hr 15 min and 21 hr 15 min as a function of pH, NaCl concentration, and polyelectrolyte concentration compared to a control at pH=7 (no coagulant added). According to FIG. 19, raising the pH to 8.5 and 10 does not significantly increase settling after 9 hr 15 min compared to the control. However, increased pH has a detrimental effect compared to the control at 21 hr 15 min. For pH 10, the supernatant arsenic concentration has stayed the same or possibly increased slightly between 9 hr 15 min and 21 hr 15 min. The high pH may be causing some arsenic to desorb from the ECAR-generated iron (hydr)oxides in solution. For pH 8.5, the supernatant arsenic clearly decreases between 9 hr 15 min and 21 hr 15 min, but is still higher than the control at 21 hr 15 min. From this it appears that increasing pH is not a viable option to increase the settling rate. FIG. 19 also shows that the addition of 0.5 or 20 μg/L NaCl does not increase settling compared to the control at 21 hr 15 min, and may decrease settling slightly. There is no significant difference in the effect at 0.5 μg/L NaCl compared to 20 μg/L NaCl. This suggest that NaCl between 0.5-20 μg/L is not an effective coagulant. Higher or lower doses may have a better effect. FIG. 19 shows the effect of adding 15 and 37 mg/L polyelectrolyte compared to the control. At 9 hr 15 min, the supernatant arsenic with the addition of polyelectrolyte is lower than the control—both polyelectrolyte samples contain 120 ppb compared to 190 ppb in the control. This suggests that polyelectrolyte may be effective as a coagulant. This contradicts earlier results that compared polyelectrolyte at concentrations of 4.6-47 mg/L to a control sample at 9 hr 30 min (FIG. 17) and found to benefit. The control sample in FIG. 17 has a concentration of 19 ppb at 9 hr 30 min compared to 190 ppb for the control in FIG. 19 at 9 hr 15 min. The difference is likely due to small changes in the operating parameters, including current density and tₚ. This suggests that polyelectrolyte may be effective as a coagulant, but only under certain operating conditions.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

We claim:

1. A system for removing arsenic from an aqueous solution, comprising: (a) an aqueous solution comprising arsenic, (b) an anode, and (c) a cathode; wherein the anode and cathode are in contact with the aqueous solution comprising arsenic and in electrical communication; wherein the anode comprises iron and the cathode comprises an electricity conducting metal that is iron or is electropositive relative to iron.

2. The system of claim 1, wherein the aqueous solution is stationary or not in motion or flowing.

3. The system of claim 1, wherein the aqueous solution is a body of arsenic contaminated water.

4. The system of claim 1, wherein the aqueous solution comprises 10 or more parts per billion (ppb) of arsenic.

5. The system of claim 4, wherein the aqueous solution comprises 100 or more parts per billion (ppb) of arsenic.

6. The system of claim 5, wherein the aqueous solution comprises 200 or more parts per billion (ppb) of arsenic.

7. The system of claim 6, wherein the aqueous solution comprises 500, or 600, or more parts per billion (ppb) of arsenic.

8. The system of claim 1, wherein the electricity conducting metal that is electropositive relative to iron is copper, silver, or carbon.

9. The system of claim 1, wherein the cathode is not structured or designed to form a reaction zone therebetween through an aqueous solution can pass.

10. The system of claim 1, wherein the cathode is structured or designed such that the electricity conducting metal that is electropositive relative to iron to have as large a surface area as possible in contact with the aqueous solution.

11. The system of claim 1, wherein the anode comprises iron nails or iron filings.

12. The system of claim 1, wherein the aqueous solution further comprises an arsenic-iron (hydr)oxide complex.

13. A method for removing arsenic from an aqueous solution comprising arsenic comprising: (a) providing the system of claim 1; (b) running a direct or alternating current through the water via the anode and cathode which causes the formation of iron (hydr)oxide from the iron of the anode; (c) forming an arsenic-iron (hydr)oxide complex; and (d) separating the arsenic-iron (hydr)oxide complex from the aqueous solution.

14. The method of claim 13, wherein the arsenic is reduced to less than 10 ppb in the aqueous solution.

15. The method of claim 14, wherein the arsenic is reduced to less than 8 ppb in the aqueous solution.

16. The method of claim 15, wherein the arsenic is reduced to less than 5 ppb in the aqueous solution.

17. The method of claim 16, wherein the arsenic is reduced to less than 3.5 ppb in the aqueous solution.

18. The method of claim 13, wherein the separating step comprises filtering the aqueous solution comprising the arsenic-iron (hydr)oxide complex with a filter such that the aqueous solution is the filtrate that passes through the filter and the arsenic-iron (hydr)oxide complex is the residue that is captured by the filter.

19. The method of claim 13, further comprising the step of replacing the anode with a second anode comprising of iron or adding more iron to the anode.

20. The method of claim 13, further comprising the step of adding a second aqueous solution comprising arsenic.

21. The method of claim 13, further comprising: (e) optionally replacing the anode with a second anode comprising of iron or adding more iron to the anode, (f) adding a second aqueous solution comprising arsenic, and repeating steps (b) to (d).

22. The method of claim 13, wherein the resultant aqueous solution is fit for human consumption.

23. The method of claim 13, wherein there is an ion permeable membrane that separates the cathode from the arsenic to be removed.

24. The method of claim 13, wherein the anode comprises iron nails or iron filings.

25. The method of claim 13, further comprising introducing a coagulant to the aqueous solution.

26. The method of claim 25, wherein the coagulant is alum, a polyelectrolyte, or a polyarcylamide, or a copolymer thereof.

27. The method of claim 13, wherein the direct or alternating current produces a charge density up to about 150,000 C/L.

28. The method of claim 13, wherein the aqueous solution has a pH value of up to about 10 pH.
